(19) United States
(12) Patent Application Publication
(10) Pub. No.: US 2007/0011247 A1
(43) Pub. Date: Jan. 11, 2007

(54) Certified email system

(76) Inventor: Paul William Bayon, Redding, CA (US)

Correspondence Address: Paul Bayon, 200 Lindsay Lane, Crescent City, CA, 95531, US

(21) Appl. No.: 11/178,070

(22) Filed: Jul. 8, 2005

(51) Int. Cl. G06F 15/16

(52) U.S. Cl. 709/206

(57) ABSTRACT

A method and process by which an email system can be controlled and limits applied so that spamming and plishing can be avoided. Uncertified email is limited to a small amount per day but senders of email can be certified by receivers of email thus avoiding the limits. This certification process can also be used so that real and valid bulk email can be sent out having a certified email address list.

### CROSS REFERENCE TO RELATED APPLICATION

Not Applicable

### FEDERALLY SPONSORED RESEARCH

Not Applicable

### SEQUENCE LISTING OR PROGRAN

Not Applicable

### BACKGROUND OF THE INVENTION—FIELD OF INVENTION

This invention relates to the field of email and keeping unwanted spam or the use of plishing out of the email system.

### BACKGROUND OF THE INVENTION

Currently spam is a major problem for all email users and various current methods to avoid it have not stopped the flood of spam clogging up email systems.

### BACKGROUND OF THE INVENTION—OBJECTS AND ADVANTAGES

This invention relates to a method to avoid spam by not letting it into the system in the first place. Currently Microsoft has a “Sender ID” program and Yahoo and Cisco are working on a “Domainkey” System to help identify senders. Neither of these has a process to certify valid senders to receivers. The first step is having every email be started with a secure and encrypted shell or header that contains a valid from address as well as other information. The second is limits as to the number of outgoing emails are placed on email that does not qualify as certified. The third is to have people build lists of valid and certified email contacts so that email sent from a certified address automatically goes through the system. The fourth is that included in the header is a set of buttons so that the receiver can classify whether the email is spam or certified and that the collection of information can be used to police the email system. That fifth is that a verifiable way is set up so that valid bulk mail can be set up and controlled. By getting rid of the junk email, the threats from viruses and other problems can be limited also.

### SUMMARY

A method and process by which an email system can be controlled and limits applied so that spamming and plishing can be avoided.

### DETAILED DESCRIPTION

Currently the email system is being overrun with spam and plishing. This is caused by the sending of emails from bulk senders to many receivers based on any email addresses the bulk sender can find. This occurs whether or not the receiver wants bulk email or has requested to be on the sender's bulk email list. One way the spammers get into the system is that they use a fake “from addresses.” To keep spam out of the system it needs to be stopped before it even enters the system. A new method needs to be introduced so that an email sender opens up a secure email shell or email with secured and encrypted header information from the very beginning of the mail process. This is even before the email reaches a company's own email server before going out on to the World Wide Web. They can add any writing or attach whatever they want to the shell but the email itself including the header information is secure and encrypted. When the email goes through the World Wide Web towards the recipient the header information cannot be changed. This header information would limit a user to a very limited number of emails per day (like 10-20 excluding any email contacts setup as certified receivers or validated bulk receivers). The second step is The process by which general users set up validated email contacts so that the system has certified receivers. This is done once an email is received. Included in the header are buttons. There would be a “spam button” and a “certified button.” A user wishing to accept the sender as a certified sender would push the certified button. This would send an email verification back to the sender setting up the receiver as a certified contact. In the future when email was received the certified button would be replaced by a “neutral button.” At any time in the future the receiver could change the certified receiver status by selecting the neutral button and automatically be deleted as a certified receiver. The user could also choose to treat the email as spam. By pushing the spam button the system would send information to a central data processing point so that senders that get too many charges of spam could be dealt with or excluded from the system. For those valid reasons to send out bulk mail, a method to set a validated bulk email address list would be instituted. A user in signing up for a bulk mail situation would go to a specialized location, put in their signup information and then the bulk mailer would have to send a specialized email to the receiving person so that that the receiver could once again press the “certified button” thus establishing a certified bulk contact. The bulk sender would have to verify from off of this valid bulk list every time before they send out any bulk mail. Bulk mailers not having certified mail list would be limited to the same 10-20 emails per day like any other email account thus destroying their ability to spam.

I claim:

1. Encrypted email shells and headers that allow the tracking of who the sender is and other secure information including classification buttons.

2. A system that limits uncertified email to a limited number for any sender's account per day.

3. Emails that have a series of button so that a receiver can classify an email as spam, neutral or certified

4. A method by which an email receiver certifies an email sender thus enabling the sender open access to send to that receiver unlimited emails that are excluded from the limits of claim 2

5. That a validation process is used so that businesses that need to send bulk email can sent up certified bulk email address lists that are also excluded from the limits of claim 2
